(19) United States
(12) Patent Application Publication
(10) Pub. No.: US 2009/0075815 A1
(43) Pub. Date: Mar. 19, 2009

(54) Fine Tetrahedral Palladium Particle and Process for Producing Fine Metallic Particle

(75) Inventors: Kiyotomi Kaneda, Hyogo (JP); Takashi Ito, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignees: N.E. CHEMCAT CORPORATION, Minato-ku, Tokyo (JP); OSAKA UNIVERSITY, Suita-shi, Osaka (JP)

(21) Appl. No.: 12/282,183

(22) PCT Filed: Mar. 9, 2007
(86) PCT No.: PCT/JP2007/054727

§ 371 Date: Sep. 9, 2008

(30) Foreign Application Priority Data
Mar. 9, 2006 (JP) 2006-064813

(51) Int. Cl. B01J 23/44; B32B 5/16; C22C 5/04; B01F 17/00

(52) U.S. Cl. 502/339; 428/402; 516/9; 420/463

(57) ABSTRACT

An object of the present invention is to provide tetrahedral fine palladium particles having a high degree of shape selectivity, and a process for producing fine metal particles.

The present invention provides fine palladium particles comprising particles having a tetrahedral shape in a proportion of 60 to 100% by number of particles; a palladium colloid obtained by uniformly dispersing the fine palladium particles within a solvent; a supported catalyst comprising the fine palladium particles dispersedly supported on the surface of, and/or in the pores of, a carrier comprising at least one of a ceramic, a carbon, and an organic polymer; a process for producing fine metal particles comprising: dissolving a tetranuclear precursor metal complex within a solvent to generate a uniform solution, and shape-selectively generating tetrahedral particles by decomposing the metal complex within the uniform solution; and a process for producing a catalyst, comprising bringing the above colloid into contact with a carrier comprising at least one of a ceramic, a carbon, and an organic polymer. The colloid or the catalyst prepared by supporting the colloid on a carrier exhibits a high level of activity and high selectivity in carbon-carbon bond-forming reactions, hydrogenation reactions and the like.

### TECHNICAL FIELD

The present invention relates to fine palladium particles. Furthermore, the present invention also relates to a palladium colloid obtained by uniformly dispersing the fine palladium particles within a solvent, and a catalyst comprising the fine palladium particles supported on a carrier. In addition, the present invention also relates to a process for producing fine metal particles, and a process for producing a catalyst in which the above palladium colloid is supported on a carrier.

### BACKGROUND ART

Fine metal particles, and particularly metal nanoparticles, have unique physical and chemical properties, and industrial application of such particles is therefore attracting considerable attention. The physical properties and functions of fine metal particles are mainly dependent on the particle size and shape, and considerable effort has been expended in the development of processes for producing fine metal particles in which the particle size and shape have been controlled. In terms of the particle shape, fine particles having a spherical shape, a cuboctahedral shape in which the apexes of a regular octahedral shape have been cut off and removed, or a regular icosahedral shape can be produced relatively easily, but there are only limited reports relating to processes for selectively producing tetrahedral metal nanoparticles, in which the particle surfaces have only {111} crystal planes.

In the case of tetrahedral fine particles of platinum, Narayanan and El-Sayed obtained tetrahedral platinum nanoparticles in a proportion of approximately 54% (wherein the proportion of the number of particles of a specific shape within the total number of metal particles, namely the shape selectivity, is expressed as a %, this also applies in the following description) by conducting a hydrogen reduction of a platinum (IV) complex salt within an aqueous solution containing an organic polymer protective agent (Non-patent Reference 1 and Non-patent Reference 2). Furthermore, there is also a report of obtaining a platinum nanoparticle colloid comprising tetrahedral particles with a shape selectivity of approximately 11 to 63% by adding an organic polymer to an aqueous solution of a platinum (II) salt and then conducting a hydrogen reduction (Patent Reference 1), as well as a report of using a colloid prepared in a similar manner to produce a carbon-supported electrode catalyst containing approximately 50% of tetrahedrally shaped platinum nanoparticles (Patent Reference 2). These reports relate to platinum nanoparticles, which are produced by hydrogen reduction of a platinum salt, in the presence of an organic polymer protective agent to maintain the dispersion.

On the other hand, there have been almost no reports relating to the selective production of tetrahedral fine particles of palladium. Torigoe and Esumi obtained a mixture of tetrahedral and octahedral particles by subjecting a water-insoluble palladium complex to photoreduction within a micelle, using an organic polymer gel network as a protective agent (Non-patent Reference 3), but the selectivity for tetrahedral particles was insufficient.

On the other hand, it is known that palladium exhibits excellent catalytic action as a homogeneous complex catalyst within a wide range of organic chemical reactions, including C—C bond-forming reactions and Wacker oxidation reactions of olefins. Furthermore, supported palladium catalysts that have been supported on alumina or carbon are also used as heterogeneous solid catalysts in a wide range of applications, including the hydrogenation of olefins, acetylenes, nitro groups, ketones, aldehydes, nitriles and the like, the oxidation of hydrogen, hydrocarbons and carbon monoxide, and the oxidative acetoxylation reactions of olefins.

Research has long been conducted into the crystal planes and catalytic reactivity of noble metal catalysts such as palladium and platinum, and the {111} plane has been identified as being the most highly active (Non-patent references 4 and 5).

Accordingly, it can be inferred that because no technique has existed until now for shape-selectedly preparing fine tetrahedral palladium particles, the action of the palladium {111} plane within practical catalysts has been inadequate.

On the other hand, C—C bond-forming reactions have been widely studied using platinum and palladium nanoparticles as catalysts, as they are reactions in which the catalytic performance is highly dependent on the particle shape. In the Suzuki coupling reaction, in which a cross-coupled biphenyl product is obtained from an aryl halide and phenylboronic acid, it has been reported that when a catalyst of tetrahedral platinum nanoparticles is used, the tetrahedrally shaped particles change to a spherical shape upon reaction, with the proportion of the tetrahedral particles decreasing rapidly (Non-patent Reference 6).

Furthermore, it has been reported that when a Suzuki coupling reaction is conducted using spherical or regular cuboctahedral palladium nanoparticles as the catalyst, growth occurs in the palladium particle size, and the activity of the recovered catalyst is dramatically reduced (Non-patent Reference 7).

Originally, the Suzuki coupling reaction was developed with a homogeneous complex catalyst having a phosphine ligand, but in a homogeneous reaction system, the operation of separating the product and the catalyst following completion of the reaction is complicated, and in those cases where a product with a high degree of purity is required, such as the case of electronic materials, the incorporation of minute quantities of palladium or phosphine ligands has an adverse effect on the quality of the product. In the case of a supported catalyst, a complicated separation operation such as that required for a complex catalyst is unnecessary, but conventional supported palladium catalysts have been unable to provide the level of activity obtainable using complex catalysts. In the Suzuki coupling reaction of an aryl halide and phenylboronic acid, the order of reactivity of the various aryl halides is represented by: aryl iodide>aryl bromide>aryl chloride, and although conventional supported catalysts exhibit activity relative to aryl iodides, their activity relative to aryl bromides is inadequate. Moreover, with low-cost aryl chlorides, the reaction proceeds hardly at all. Furthermore, with conventional supported palladium catalysts, reactions of a substituent-bearing aryl halide with phenylboronic acid yield not only the targeted cross coupled product, but also by-products from homocoupling reactions between molecules of the aryl halide and between molecules of the phenylboronic acid. In this manner, depending on the reaction, conventional palladium catalysts have not always been entirely satisfactory in terms of their activity, selectivity and stability.

Patent Reference 1: Japanese Laid-open patent publication (kokai) No. 2005-248203

Patent Reference 2: Japanese Laid-open patent publication (kokai) No. 2002-042825

Non-patent Reference 1: R. Narayanan, M-A. El-Sayed, Abstracts of Papers, 227th ACS Bational Meeting, Anaheim, Calif., United States, Mar. 28 to Apr. 1, 2004, PHYS-101 (2004).

Non-patent Reference 2: R. Narayanan, M-A. El-Sayed, Langmuir, 21(5), 2027-2033 (2005)

Non-patent Reference 3: K. Torigoe and K. Esumi, Langmuir, 11, 4199-4201 (1995)

Non-patent Reference 4: T. M. Gentle, E. L. Muetterties, J. Phys. Chem., 87, 2469 (1983)

Non-patent Reference 5: T. G. Rucker et al., J. Phys. Chem., 90, 2703 (1986)

Non-patent Reference 6: R. Narayanan and M. A. El-Sayed, Langmuir, 21, 2027 (2005)

Non-patent Reference 7: R. Narayanan and M. A. El-Sayed, J. Am, Chem. Soc., 125, 8340 (2003)

### DISCLOSURE OF INVENTION

### Problems Invention Aims to Solve

Tetrahedral metal particles have only {111} crystal planes on their surfaces. Until now, although processes for producing tetrahedral nanoparticles have been developed for platinum, in the case of palladium, these conventional production processes tend to yield spherical or amorphous particles, and no selective process for producing fine tetrahedral particles is known. The present invention provides a process for producing shape-selective tetrahedral fine palladium particles and metal fine particles.

### Means for Solution of the Problems

In order to address the problems described above, the present invention provides fine palladium particles that comprise particles having a tetrahedral shape in a proportion (calculated in terms of the number of particles, this also applies below) of 60 to 100%. Moreover, the present invention also provides fine palladium particles that comprise particles having a tetrahedral shape in a proportion of 72 to 95% by number of particles. Furthermore, the present invention also provides tetrahedral fine palladium particles in which the number average particle size is within a range from 0.5 to 100 nm. Furthermore, the present invention also provides tetrahedral fine palladium particles in which the number average particle size is within a range from 1 to 50 nm. Moreover, the present invention also provides tetrahedral fine palladium particles in which the number average particle size is within a range from 1 to 30 nm.

Furthermore, the present invention also provides a palladium colloid obtained by uniformly dispersing the tetrahedral fine palladium particles within a solvent. Moreover, the present invention also provides a colloid obtained by uniformly dispersing the tetrahedral fine palladium particles within an aprotic polar solvent. Moreover, the present invention also provides a colloid of tetrahedral fine palladium particles that contains none of the organic polymer protective agents or surfactant micelles typically used in the production of conventional fine particles. On the other hand, the present invention also provides a tetrahedral palladium colloid that has been stabilized with a protective agent.

Furthermore, the present invention also provides a supported catalyst comprising the tetrahedral fine palladium particles dispersedly supported on the surface of, and/or in the pores of, a carrier comprising at least one of a ceramic, a carbon, and an organic polymer. Moreover, the present invention also provides a supported catalyst comprising the tetrahedral fine palladium particles dispersedly supported on a titania, alumina, silica, silica-alumina, zeolite, hydroxyapatite, or carbon.

Moreover, the present invention also provides a catalyst that can be used in at least one reaction selected from amongst carbon-carbon bond-forming reactions, hydrogenation reactions, hydrocracking reactions, oxidation reactions and dehydrogenation reactions, wherein the catalyst comprises tetrahedral fine palladium particles, either in the form of a colloid that is not supported on a carrier, or in the form of a supported catalyst in which the particles are dispersedly supported on the surface of, and/or in the pores of, a carrier comprising at least one of a ceramic, a carbon, and an organic polymer.

The present invention provides a process for producing fine metal particles that comprises dissolving a tetranuclear precursor metal complex within a solvent to generate a uniform solution, and shape-selectively generating tetrahedral particles by decomposing the metal complex within the uniform solution. Furthermore, the present invention also provides a process for producing tetrahedral fine metal particles, wherein the decomposition of the tetranuclear precursor metal complex is conducted within an oxygen-containing atmosphere. Moreover, the present invention also provides a production process in which the tetrahedral fine metal particles are obtained by decomposing a tetranuclear metal complex that contains a carbonyl ligand. Furthermore, the present invention also provides a production process in which the tetrahedral fine particles of a metal are obtained by decomposing a tetranuclear metal complex that contains an aliphatic or aromatic carboxylate ligand. Moreover, the present invention also provides a process for producing tetrahedral fine particles of a metal in which the tetranuclear precursor metal complex is dissolved in an aprotic polar organic solvent. The present invention also provides a process for producing tetrahedral fine particles of a metal in which the polar solvent is a carboxylic acid amide. The present invention also provides a process for producing tetrahedral fine particles of palladium that comprises decomposing a tetranuclear palladium complex.

The present invention also provides a process for producing a supported catalyst containing tetrahedral fine metal particles, the process comprising bringing a colloid, obtained by uniformly dispersing tetrahedral fine particles of the metal within a solvent, into contact with a carrier comprising at least one of a ceramic, a carbon, and an organic polymer.

### EFFECTS OF INVENTION

Tetrahedral fine palladium particles having a high degree of shape selectivity, a favorable dispersive state and a sharp particle size distribution, and a colloid obtained by dispersing those fine particles in an organic solvent are obtained, and by using these particles and colloid, a tetrahedral palladium colloidal catalyst and a supported tetrahedral palladium catalyst can be obtained that exhibit a high level of activity and high selectivity in all manner of catalytic reactions.

### BEST MODE OF CARRYING OUT INVENTION

A more detailed description of the present invention is provided below. In the present invention, the term “room temperature” means a temperature from 15 to 25° C. Furthermore, molecular weights are measured by gel permeation chromatography, and refer to weight average molecular weights referenced against polystyrene standards. Moreover, groups represented by “Ar”, “Ph” and “Ac” represent aryl groups, phenyl groups and acetyl groups, respectively.

Tetrahedral fine metal particles of the present invention are produced using a tetranuclear metal complex as a precursor. The tetranuclear metal complex preferably comprises a carbonyl (CO) ligand or carboxylate ligand, and most preferably comprises both a carbonyl ligand and a carboxylate ligand.

The carboxylate may be either an aliphatic and/or aromatic carboxylate, and in the case of an aliphatic carboxylate R—COO (wherein R represents an unsubstituted or substituted aliphatic hydrocarbon group), there are no particular restrictions on the structure of R, although C₁ to C₁₂ alkyl groups, aralkyl groups, halogenated alkyl groups, halogenated aralkyl groups and the like can be used favorably. Groups such as CH₃, CF₃, CH₂C₁, C₂H₅, C(CH₃)₃ and the like are particularly desirable.

Furthermore, in the case of an aromatic carboxylate Ar—COO, there are no particular restrictions on the structure of Ar, although Ph, CH₃-Ph, Cl-Ph and the like can be used favorably.

In those cases where the metal is palladium, particularly preferred tetranuclear complexes include the palladium carbonyl acetate complex Pd₄(CO)₄(OAc)₄.2AcOH (hereafter abbreviated as PCA) and the palladium carbonyl benzoate complex Pd₄(CO)₄(OCOPh)₄ (hereafter abbreviated as PCB). These tetranuclear complexes can be produced using known, documented production processes. For example, if carbon monoxide (CO) is bubbled through an acetic acid solution of palladium acetate at 50° C., then partial reduction of the palladium occurs, yielding the tetranuclear palladium carbonyl acetate complex PCA (for example, I. I. Moiseev et al, J. Chem. Soc., Chem. Commun., 27 (1978); I. I. Moiseev, J. Organomet. Chem., 488, 183 (1995)).

If this PCA complex is added to a toluene solution of an aliphatic or aromatic carboxylic acid, and then stirred under an argon atmosphere, then a tetranuclear complex is obtained in which the acetate portions of the PCA ligands have been replaced with the corresponding aliphatic or aromatic carboxylate.

By dissolving the tetranuclear metal complex in an organic solvent, preferably an aprotic polar organic solvent, and even more preferably a carboxylic acid amide solvent, thereby forming a uniform solution, and then decomposing the complex by stirring the solution for a certain period of time at room temperature, preferably under an oxygen-containing atmosphere, a uniform colloidal dispersion/solution containing the tetrahedral fine metal particles of the present invention is obtained.

Conventionally, when producing a colloid of fine metal particles, a protective agent (also referred to as a dispersant or stabilizer) is often used to stabilize the colloid through suppression of aggregation of the generated fine particles or particle size growth. by coordination or adsorption thereof at the surfaces of the fine particles. Furthermore, in the production of conventional shape-selective fine metal particles, a templating agent such as an organic polymer or micelle is used to control the direction of crystal growth from the nascent fine metal particle nuclei.

Compared with these conventional processes for producing fine metal particles, a marked feature of the production process of the present invention is the fact that a colloid of monodisperse tetrahedral fine metal particles can be obtained even in the absence of a templating agent, which is an essential component in the conventional production processes, namely, via a so-called self-assembly.

Addition of a protective agent contributes to stabilization of the dispersion of the generated tetrahedral fine particles, but when the tetrahedral fine particles are used in a subsequent step, coordination of the protective agent can be a hindrance. For example, when the tetrahedral fine particles are supported on a carrier and used as a catalyst, the protective agent may cover active sites of the catalyst and not be removable, thereby inhibiting the catalytic activity, and therefore it may be preferable not to add a protective agent in some cases.

In the production of tetrahedral fine metal particles of the present invention, compared with those cases where a non-polar organic solvent such as benzene, toluene, xylene, hexane, or heptane is used, cases in which an aprotic polar organic solvent is used result in more ready production of the tetrahedral fine metal particles, and also yield a satisfactorily rapid production rate. Ketones, esters, amides, ethers and the like may be used as the aprotic polar organic solvent, but of these, acid amide solvents such as dimethylformamide, dimethylacetamide, dimethylpropionamide and N-methylpyrrolidone are preferred.

Although there are no particular restrictions on the concentration of the metal within the colloidal solution of the present invention, the concentration is typically within a range from 0.1 mmol/l to 1 mol/l, is preferably from 1 mmol/l to 500 mmol/l, and is even more preferably from 10 mmol/l to 200 mmol/l. Provided the concentration is within this range, the quantity of solvent required is unlikely to be excessive, and the fine metal particles are less likely to aggregate, both of which are desirable.

Furthermore, the decomposition reaction of the tetranuclear complex is preferably conducted within an oxygen-containing atmosphere. The effect of the oxygen is not entirely clear, but it is presumed to accelerate the desorption of the carbon monoxide and carboxylate ligands, and the reduction of the tetranuclear complex metal ion to a zero valent metal state. Compared with using an inert gas atmosphere, conducting the decomposition under an oxygen-containing atmosphere tends to lower the proportion of fine metal particles of different shapes, which is thus desirable.

Although there are no particular restrictions on the temperature of the decomposition reaction, the reaction is preferably conducted at a temperature within a range from −20° C. to 120° C., more preferably from 0° C. to 100° C., and even more preferably from 15° C. to 60° C., and for convenience sake, is preferably conducted at room temperature.

The decomposition reaction holding time is set appropriately in accordance with the required particle size for the tetrahedral fine particles. The time is typically within a range from 30 seconds to 8 hours, more preferably from 1 minute to 5 hours, and is even more preferably from 3 minutes to 2 hours. Provided the holding time is within the above range, growth of the particle size of the tetrahedral fine particles is more readily prevented, the probabilities of aggregation or the generation of large particles of different shapes are more readily reduced, the crystal shape of the nanoparticles is more easily stabilized, and formation of the tetrahedral crystal planes is more likely to proceed satisfactorily, all of which are desirable.

Following stirring for a certain period in the open air to obtain a colloid of tetrahedral fine metal particles of a predetermined particle size, if the colloidal solution is purged by bubbling an inert gas through the solution, then sealed in an inert gas atmosphere and stored at rest at a temperature of room temperature or lower, then particle size growth can be halted.

On the other hand, in those cases where the tetrahedral fine metal particles of the present invention are to be stored in colloid form for an extended period at room temperature, or in those cases where, due to the actual application of the colloid, addition of a protective agent causes no hindrance, a tetrahedral fine metal particles colloid containing an added protective agent may be prepared. The protective agent may be added to the precursor metal complex solution in advance, prior to generation of the tetrahedral fine metal particles, or may be added to the colloidal solution following generation of the tetrahedral fine metal particles. In other words, the protective agent or a templating agent is not necessary for the actual production of the tetrahedral fine metal particles of the present invention, and the decision as to whether or not to employ a protective agent can be made solely on the basis of the need to stabilize the produced tetrahedral fine particles in accordance with the actual application.

Any of the materials typically used as protective agents for conventional metal colloids can be used as the protective agent for the tetrahedral fine metal particles colloid of the present invention. For example, organic polymers, or low molecular weight organic compounds that contain a hetero atom such as a nitrogen, phosphorus, oxygen or sulfur atom and exhibit a powerful coordinating force can be used as the protective agent. Examples of organic polymer protective agents that can be used include polymer compounds such as polyamides, polypeptides, polyimides, polyethers, polycarbonates, polyacrylonitriles, polyacrylic acids, polyacrylates, polyacrylamides, polyvinyl alcohols, heterocyclic polymers and polyesters. Particularly favorable polymers include polyvinylpyrrolidones, polyethylene glycols and polyacrylamides. These can be used in various forms including chain-like polymers, graft polymers, comb polymers, star block copolymers and dendrimers. Polyamidoamine dendrimers, polypropyleneimine dendrimers, and phenylazomethine dendrimers can be used favorably as the dendrimer. The molecular weight of the polymer can be selected appropriately within a range from thousands to millions, provided the polymer can be dissolved in the solvent to form a uniform colloid of the fine metal particles.

On the other hand, examples of low molecular weight, powerful coordinating protective agents that can be used include compounds such as tertiary amines, tertiary phosphines and mercaptans, which can be selected in accordance with the application. Furthermore, clathrate compounds such as cyclodextrin, crown ethers or calixarene may also be used as the protective agents.

Observation and measurement of the distribution of the particle shape and particle size of the tetrahedral fine palladium particles of the present invention can be conducted with either one device, or a combination of two or more devices, selected from amongst a high-resolution transmission electron microscope (HR-TEM), a transmission electron microscope (TEM), a field emission scanning electron microscope (FE-SEM), and a scanning electron microscope (SEM).

When a palladium colloidal solution of the present invention is deposited on a carbon grid, and the particle shape and particle size are observed using a HR-TEM or TEM, a multitude of dispersed triangular crystals are observed in which the length of one side is preferably within a range from 0.5 to 100 nm, more preferably from 1 to 50 nm, and even more preferably from 1 to 30 nm. When observed using a HR-TEM, a crystal lattice image corresponding with the fcc Pd{111} plane is observed inside these triangular shapes. When the shapes of 100 or more particles within the TEM observation field are classified as triangular, square, circular, another polygonal shape, or an aggregate thereof, the numbers of particles having each of these shapes is counted, the number of particles of each shape is divided by the total number of particles to calculate a proportion, and the resulting shape distribution is determined (wherein the shape distribution is calculated in terms of a “number of particles”, this also applies below), the particles of triangular shape are typically observed in a proportion of 60% to 100%, and are preferably observed in a proportion of 72% to 95%. In the present description, the proportion of particles of triangular shape observed by TEM is taken to represent the proportion of tetrahedral particles. However, in the TEM observation, there is a possibility that, besides the triangular shapes, even a square shape may, due to shading, correspond with the transmission image of a tetrahedral particle, and if this factor is also taken into consideration, then it is presumed that the actual proportion of tetrahedral particles will be even higher than the proportion calculated from the proportion of triangular shapes.

Furthermore, if the above colloid is observed using a FE-SEM or SEM, then a multitude of dispersed tetrahedral nanoparticles having a brightly shining apex within the inside of a triangular exterior shape are observed.

Even if a triangular transmission image is observed in the TEM image, there is a possibility that the image may actually represent the cross-sectional view of a triangular prism (for example, J. E. Millstone et al., J. Am. Chem. Soc., 127, 5312 (2005)) or a triangular plate (for example, Y. Xiong et al., J. Am. Chem. Soc., 127, 17118 (2005)), but in the case of the fine palladium particles of the present invention, inspection of the three-dimensional shading using a SEM image confirms that almost no triangular prisms or triangular plates exist, indicating the particles are tetrahedral particles.

A feature of the tetrahedral fine palladium particles of the present invention is their sharp particle size distribution. The variation in particle size relative to the average particle size D (nm) is preferably such that: 3σ<0.3×D (nm) (wherein, a represents the standard deviation for the particle size distribution), and even more preferably such that 3σ<0.15×D (nm).

The tetrahedral fine palladium particles supported catalyst of the present invention is prepared by bringing a colloidal solution of the tetrahedral fine palladium particles into contact with a carrier. For example, by dissolving a tetranuclear palladium complex in an organic solvent, preferably an aprotic polar organic solvent, and even more preferably an amide solvent, thereby forming a uniform solution, and then stirring the solution for a certain period of time at a certain temperature (for example, room temperature), under an oxygen-containing atmosphere, a uniform colloidal dispersion/solution containing tetrahedral fine palladium particles is obtained, and by adding a powdered or granulated catalyst carrier to this colloidal solution, stirring for a certain period of time at room temperature, and then filtering, washing and drying the product, a supported catalyst is obtained in which the tetrahedral fine particles are dispersedly supported on the surface of, and/or within the pores of the catalyst carrier. In one example of this production process, the tetranuclear metal complex and a powder or granules of the catalyst carrier may be added to the organic solvent at the same time, so that at the same time the metal complex dissolves and is subsequently decomposed to generate the tetrahedral fine metal particles, the fine particles are also supported on the coexistent carrier.

In those cases where a molded catalyst carrier is used, the supported catalyst can be prepared by a so-called water absorption method, by stirring the dry catalyst carrier using an impregnator or the like, while the colloidal solution is dripped onto the carrier.

Examples of catalyst carriers that can be used include general-purpose ceramic carriers such as alumina, silica, silica-alumina, zeolite, titania, zirconia, silicon carbide and hydroxyapatite, carbon carriers such as activated carbon, carbon black, carbon nanotubes and carbon nanohorns, and organic polymer carriers such as polystyrene and styrene-divinylbenzene copolymers.

There are no particular restrictions on the form of the carrier, and typical carrier forms such as powders, beads, pellets and honeycombs can be used.

A monolith such as a metal honeycomb or mesh of stainless steel or the like, or a ceramic honeycomb or the like of a cordierite or silicon carbide or the like may be used as a support, and the surface of the support may be covered with a wash coat layer of a porous carrier such as alumina or titania, and the colloid may be then brought into contact with the wash-coat layer, thereby causing the palladium tetrahedral nanoparticles within the colloid to be adsorbed to the wash-coat layer and generating a monolithic catalyst.

In the step of supporting the particles onto this carrier, the tetrahedral shape and particle size of the palladium do not alter, and the shape and particle size that exist in the colloidal state are retained. For example, adding a tetranuclear palladium complex to an amide solvent and then stirring at room temperature for 5 minutes yield a colloidal solution, which when observed using a TEM reveals tetrahedral nanoparticles with a single side length of 5 nm, and if a quantity of titania (TiO₂) powder equivalent to a 20-fold excess, by weight, relative to the colloidal solution is then added and stirred, and after one hour the mixture is filtered, washed and dried, then a supported palladium titania powder is obtained, and observation of this supported catalyst using a TEM confirms that the palladium tetrahedral nanoparticles are dispersedly supported with the single side length maintained at 5 nm.

In the tetrahedral palladium supported catalyst of the present invention, there are no particular restrictions on the quantity of palladium supported on the carrier. The quantity supported can be selected in accordance with the application and the purpose. Provided satisfactory activity and durability can be obtained, a smaller quantity is preferred. Generally, the quantity of supported palladium is within a range from 0.01 to 50% by weight, preferably from 0.05 to 40% by weight, and even more preferably from 0.1 to 20% by weight, relative to the total weight of the catalyst.

The palladium colloid of the present invention and the supported catalyst prepared by supporting the palladium colloid on a porous carrier exhibit characteristic activity and selectivity within all manner of reactions that proceed with conventional palladium catalysts, including carbon-carbon bond-forming reactions, hydrogenation reactions, hydrocracking reaction, oxidation reactions and the like, due to the fact that the crystal structure is a tetrahedral shape composed solely of {111} planes.

The colloid of tetrahedral fine palladium particles of the present invention exhibits a particularly high level of catalytic activity for carbon-carbon bond-forming reactions. In a Suzuki coupling reaction between an aryl halide and phenylboronic acid, a tetrahedral palladium colloidal catalyst of the present invention enables reaction completion within several hours, preferably from 1 to 8 hours, even for an aryl bromide, and the biphenyl product is obtained with a yield of 99%. Even in the case of aryl chlorides, which are known to have extremely low reactivity, the biphenyl product is obtained with a yield of approximately 30 to 50% after more than 10 to 24 hours.

Furthermore, if a supported catalyst of the present invention is used, then the Suzuki coupling reaction proceeds with a high yield even for a heterogeneous system. Cross coupling of an aryl bromide, which with a conventional supported palladium catalyst suffers from an unsatisfactory yield, proceeds almost quantitatively within several hours, and preferably from 1 to 3 hours. Even in the case of an aryl chloride, the biphenyl is obtained with a suitable yield of approximately 30 to 50% after a period of between more than ten hours and several tens of hours, and preferably a period of 10 to 24 hours.

With the colloidal catalyst or supported catalyst of the present invention, the reaction between a substituent-bearing aryl halide and phenylboronic acid produces almost no homocoupling reaction by-products between molecules of the aryl halide or molecules of the phenylboronic acid, and the cross coupling product is obtained with a selectivity of >99%.

Furthermore, with the colloidal catalyst or supported catalyst of the present invention, almost no change occurs in the shape or particle size of the palladium before and after the catalytic reaction, elution of the palladium into the reaction system is of a level that can be ignored, and the catalyst can be easily recovered from the reaction system by filtration and then reused in the next reaction cycle with good retention of the activity and selectivity.

This property is markedly different from that of the existing tetrahedral platinum nanoparticles catalyst (Non-patent Reference 6), in which the tetrahedral shape was reported to change to a spherical shape, with a rapid fall in the proportion of tetrahedral particles, each time the Suzuki coupling reaction was conducted. Furthermore, this property is also superior to existing spherical palladium nanoparticles catalysts, in which growth of the palladium particle size is reported to occur following the Suzuki coupling reaction.

The tetrahedral palladium catalyst of the present invention also exhibits a high level of activity for the normal temperature, normal pressure hydrogenation reaction of an acetylene to an olefin. Because the reaction conditions are mild, sequential hydrogenation of the olefin to a saturated C—C bond is avoided, enabling the reaction to be halted at the olefin.

A tetrahedral palladium colloid that has been stabilized with a protective agent according to the present invention can be used as a colloidal catalyst provided the protective agent does not inhibit the target reaction. For example, the stabilized colloid can be used as catalyst seed crystals for conducting electroless plating of a noble metal such as gold, silver or platinum onto the surface of a metal, glass or plastic substrate.

### EXAMPLES

Examples and comparative examples of the present invention are presented below, but the present invention is in no way limited by the following examples.

### Reference Example 1

### Synthesis of a Palladium Tetranuclear Complex (PCA)

In accordance with the process described in Non-patent References 4 and 5, a palladium tetranuclear complex (PCA) was produced in the manner described below. 0.40 g of palladium acetate Pd(OAc)₂ (manufactured by N.E. Chemcat Corporation) was dissolved in 40 ml of acetic acid, and was then stirred for 2 hours at 50° C. under a stream of carbon monoxide, yielding 0.24 g of a tetranuclear palladium complex PCA as yellow crystals.

### Reference Example 2

### Synthesis of a Palladium Tetranuclear Complex (PCB)

To a solution obtained by dissolving 2.2 g of benzoic acid in 20 ml of toluene was added 0.36 g of the above PCA complex, the mixture was stirred for 2 hours at 45° C. under a stream of argon, and the produced crystals were washed with toluene and then dried under vacuum, yielding 0.12 g of a yellow-brown PCB complex.

### Example 1

### Production of a Tetrahedral Palladium Colloid PCA(DMA)^{5 min}

0.020 g of the above tetranuclear palladium complex PCA was added to 1 ml of N,N-dimethylacetamide (DMA), and the resulting solution was stirred in the air at 25° C. The initially yellow-colored solution changed to a light brown color after 1 to 2 minutes, and after 5 minutes, yielded a uniform dark brown colloid PCA(DMA)^{5 min}. When this colloid was deposited onto a carbon grid, dried, and then observed using a TEM (Hitachi H800, accelerating voltage: 200 kV) and a HR-TEM (Hitachi H9000, accelerating voltage: 300 kV), a state was observed in which triangular nanoparticles of comparatively uniform shape were favorably dispersed, and particles of other shapes were extremely few. The shapes and particle sizes (the length of one side in the case of a triangle, the diameter in the case of a circle, and the geometric representative diameter, namely the diameter of the corresponding circle having the same area, in the case of a particle of another shape) of 150 particles within a representative field of view were listed, the shape of each particle was classified as triangular, other polygonal through to circular, aggregate, or amorphous of indeterminable shape, the number of particles of each classification was divided by the total number of particles to produce a shape distribution, and the number average particle size was also determined. The results were triangular: 75%, other polygonal through to circular: 17%, aggregate: 2%, and amorphous: 6%. Based on these results, the shape selectivity for tetrahedral particles was estimated at 75%. The number average particle size was 6.0 nm, and the variation therein 3σ was 0.7 nm.

### Example 2

### Production of a Tetrahedral Palladium Colloid PCA(DMA)^{70 min}

In Example 1, with the exception of not halting the stirring in air after 5 minutes, but rather extending and continuing the stirring for 70 minutes, processing was performed in the same manner as Example 1, yielding a dark brown colloid PCA(DMA)^{70 min}. Based on a TEM observation, shape analysis was performed in the same manner as Example 1, and the tetrahedral shape selectivity was estimated at 70%. The number average particle size was 15 nm, and the variation therein 3σ was 2.5 nm.

### Example 3

### Production of a Tetrahedral Palladium Colloid PCA(DMF)^{70 min}

In Example 2, with the exception of using N,N-dimethylformamide (DMF) instead of the solvent DMA, processing was performed in the same manner as Example 2, yielding a tetrahedral palladium colloid PCA(DMF)^{70 min}. Based on a TEM observation, the tetrahedral shape selectivity was calculated to be 78%. The number average particle size was 10 nm, and the variation therein 3σ was 1.5 nm.

### Example 4

### Production of a Tetrahedral Palladium Colloid PCB(DMA)^{0 min}

In Example 1, with the exception of using 0.030 g of PCB instead of the 0.020 g of PCA, processing was performed in the same manner as Example 1, and immediately following the commencement of stirring, a dark brown colloid PCB(DMA)^{0 min} was obtained. Based on a TEM observation, the tetrahedral shape selectivity was 80%. The number average particle size was 4 nm, and the variation therein 3σ was 0.5 nm.

### Example 5

### Production of a Tetrahedral Palladium Colloid PCB(DMA)^{70 min}

In Example 2, with the exception of using 0.030 g of PCB instead of the 0.020 g of PCA, processing was performed in the same manner as Example 2, yielding a dark brown colloid PCB(DMA)^{70 min}. Based on a TEM observation, the tetrahedral shape selectivity was 74%, the number average particle size was 10 nm, and the variation therein 3σ was 1.2 nm.

### Example 6

### Production of a PVP-Stabilized Tetrahedral Palladium Colloid PCA(DMA)^{5 min}/PVP

0.020 g of the above tetranuclear palladium complex PCA was added to 1 ml of N,N-dimethylacetamide (DMA), and the resulting solution was stirred in the air at 25° C. After stirring for 5 minutes, 0.02 g of a PVP powder (manufactured by Aldrich Co., Ltd., molecular weight: 40,000) was added, and stirring was continued for 50 minutes, yielding a dark brown uniform colloidal solution. Based on a TEM observation, the tetrahedral shape selectivity was 75% and the number average particle size was 6.0 nm, the same results as Example 1. This colloid was stored in air at room temperature for 10 days and then observed again using a TEM, but there was almost no change in the shape selectivity and the particle size.

### Example 7

### Production of a Tetrahedral Palladium Supported Titania Catalyst PCA(DMA)/TiO₂^{0 min}

0.020 g of the above tetranuclear palladium complex PCA and 0.154 g of a titania powder (TiO₂, a reference catalyst JRC-TIO-2 from the Catalysis Society of Japan) were added to 1 ml of N,N-dimethylacetamide (DMA), and the resulting mixture was stirred in the air at 25° C. After stirring for 50 minutes, when the stirring was halted and the mixture was left to stand, a blue-grey solid and a colorless and transparent supernatant liquid were obtained. The solid was isolated by filtration, washed with DMA, and then dried under vacuum, yielding a 6.2% by weight palladium supported titania catalyst PCA(DMA)/TiO₂ nm. Observation of this catalyst using a HR-TEM and a FE-SEM (Hitachi S-5000L, accelerating voltage: 18.0 kV) revealed that the tetrahedral fine particles had been supported on the surface of the titania in a uniformly dispersed state, with no particle aggregation. The average length of one side of the triangular shapes in the TEM image was 6.4 nm, and the particle shape distribution and particle size distribution were substantially the same as those for the colloid PCA(DMA)^{5 min}. In other words, it is speculated that even in the presence of the carrier titania particles, the tetrahedral fine palladium particles are generated in the initial stages of the reaction, in the same manner as the case where no titania is used, and are then immediately fixed to the surface of the titania particles, with good retention of the particle shape and particle size.

### Example 8

### Production of a Tetrahedral Palladium Supported Titania Catalyst PCA(DMA)/TiO₂^{70 min}

To the tetrahedral palladium colloid obtained in Example 2 was added 0.154 g of the same titania powder as that used in Example 7, and following stirring for 30 minutes in the air at 25° C., the stirring was halted, the mixture was left to stand to yield a solid and a supernatant liquid, and the solid was isolated by filtration, washed with DMA, and then dried under vacuum, yielding a supported titania catalyst PCA(DMA)/TiO₂^{70 min}. A TEM observation confirmed that the tetrahedral shape selectivity and the particle size distribution were substantially the same as those in Example 2.

### Example 9

### Production of a Tetrahedral Palladium Supported Titania Catalyst PCB(DMA)/TiO₂^{0 min}

In Example 7, with the exception of using a quantity of the complex PCB equivalent to 0.01 g of Pd instead of the complex PCA, processing was performed in the same manner as Example 7, yielding PCB(DMA)/TiO₂^{0 min}. On the basis of a TEM observation, the shape selectivity of the fine palladium particles supported on the titania was 80%, substantially the same as Example 4. The number average particle size was 4 nm, and the variation therein 3σ was 0.5 nm.

### Example 10

### Production of a Tetrahedral Palladium Supported Titania Catalyst PCB(DMA)/TiO₂^{70 min}

To 1 ml of the colloid PCB(DMA)^{70 min} obtained in Example 5 was added 0.154 g of the same titania powder as that used in Example 7, and following stirring for 30 minutes in the air at 25° C., the stirring was halted, the mixture was left to stand to yield a solid and a supernatant liquid, and the solid was isolated by filtration, washed with DMA, and then dried under vacuum, yielding a 6.2% by weight palladium supported titania catalyst PCB(DMA)/TiO₂^{70 min}. On the basis of a TEM observation, the shape selectivity of the fine palladium particles supported on the titania was 74%, substantially the same as Example 5, the number average particle size was 10 nm, and the variation therein 3σ was 1.5 nm.

### Example 11

### Production of a Tetrahedral Palladium Supported Alumina Catalyst PCA(NMP)/Al₂O₃^{0 min}

In Example 7, with the exceptions of using 1 ml of N-methylpyrrolidone (NMP) instead of the solvent DMA, and using 0.154 g of an alumina (N. Akt. I, manufactured by ICN Pharmaceuticals, Inc.) instead of the titania carrier, processing was performed in the same manner as Example 7, yielding a palladium supported alumina catalyst PCA(NMP)/Al₂O₃^{0 min}

### Example 12

### Production of a Tetrahedral Palladium Supported Alumina Catalyst PCA(NMP)/Al₂O₃^{0 min}

In Example 11, with the exception of using a reference catalyst JRC-ALO-4 from the Catalysis Society of Japan as the alumina carrier instead of the alumina manufactured by ICN Pharmaceuticals, Inc., processing was performed in the same manner as Example 11, yielding a palladium supported alumina catalyst PCA(NMP)/Al₂O₃^{0 min}.

### Example 13

### Production of a Tetrahedral Palladium Supported Hydroxyapatite Catalyst PCA(NMP)/HAP^{0 min}

In Example 7, with the exceptions of using 1 ml of N-methylpyrrolidone instead of the solvent DMA, and using 0.154 g of a hydroxyapatite (manufactured by Wako Pure Chemical Industries, Ltd.) instead of the titania carrier, processing was performed in the same manner as Example 7, yielding a palladium supported hydroxyapatite catalyst PCA(NMP)/HAP^{0 min}.

### Example 14

### C—C Bond-Forming Reaction using a Tetrahedral Palladium Colloid

A Pyrex (a registered trademark) flask was charged with 5 ml of DMF solvent, benzyl bromide (1.0 mmol), phenylboronic acid (1.5 mmol) and calcium carbonate (2.0 mmol) were added thereto, and following flushing of the inside of the flask with argon gas under stirring, the temperature was raised using an oil bath until the liquid temperature reached 130° C., and 0.11 ml of the palladium colloid obtained in Example 3 (equivalent to 0.01 mmol of Pd) was then added. The mixture was stirred for 8 hours at 130° C. under a stream of argon. Following cooling to room temperature, the reaction liquid was analyzed by gas chromatography (using an internal standard method), revealing that the target biphenyl product had been obtained with a yield of 99%. The result is shown in Table 1. The reaction scheme is shown below.

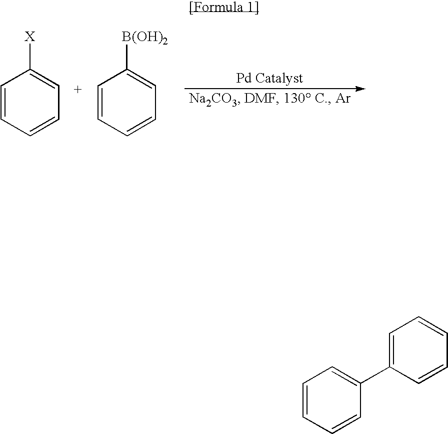

### Example 15

### C—C Bond-Forming Reaction using a Tetrahedral Palladium Colloid

In Example 14, with the exceptions of using benzyl chloride (1.0 mmol) instead of the benzyl bromide, and extending the reaction time to 24 hours, processing was performed in the same manner as Example 14, and yielded biphenyl with a yield of 31%. The result is shown in Table 1.

### Comparative Example 1

### C—C Bond-Forming Reaction using a Spherical Palladium Colloid

In accordance with the process described in Non-patent Reference 7, a spherical palladium PVP-protected colloid was produced in the manner described below. Namely, 0.09 g of palladium chloride and 6 ml of 0.2N hydrochloric acid were added to 250 ml of ion-exchanged water, 0.07 g of a polyvinylpyrrolidone PVP (manufactured by Aldrich Co., Ltd., molecular weight: 40,000) and 4 drops of 1N hydrochloric acid were added, the mixture was heated and boiled, and 14 ml of ethanol was then added and the mixture was stirred for 3 hours, yielding a dark brown palladium colloid (Pd concentration: 2 mmol/l). Observation using a TEM revealed that the proportion of fine tetrahedral particles was not more than 10%, with the majority of the particles being spherical nanoparticles, and the number average particle size was 3 nm. In Example 14, with the exception of using 5 ml of this spherical palladium PVP-protected colloid (equivalent to 0.01 mmol of palladium) instead of the tetrahedral palladium colloid obtained in Example 3, processing was performed in the same manner as Example 14, and yielded biphenyl with a yield of 27%. The result is shown in Table 1.

### Comparative Example 2

### C—C Bond-Forming Reaction using a Spherical Palladium Colloid

In Example 15, with the exception of using a quantity of the spherical palladium PVP-protected colloid obtained in Comparative Example 1 equivalent to 0.01 mmol of Pd instead of the tetrahedral palladium colloid obtained in Example 3, processing was performed in the same manner as Example 15, and yielded biphenyl with a yield of 5%. The result is shown in Table 1.

TABLE 1

| Example/Comparative example | X | Pd catalyst | Reaction time (hours) | Yield (%) |
|---|---|---|---|---|
| Example 14 | Br | PCA(DMF)^{70 min} | 8 | >99 |
| Comparative example 1 | Br | Spherical Pd-PVP colloid | 8 | 27 |
| Example 15 | Cl | PCA(DMF)^{70 min} | 24 | 31 |
| Comparative example 2 | Cl | Spherical Pd-PVP colloid | 24 | 5 |

(Note) In the table, X corresponds with the X shown in the above reaction scheme.

### Example 16

### C—C Bond-Forming Reaction using a Tetrahedral Palladium Supported Titania Catalyst

In Example 14, with the exception of replacing the palladium colloid used as the catalyst with the tetrahedral palladium supported titania catalyst PCA(DMA)/TiO₂^{0 min} obtained in Example 7 in a quantity equivalent to 0.01 mmol of Pd, processing was performed in the same manner as Example 14, and yielded biphenyl with a yield of 71%.

### Example 17

### C—C Bond-Forming Reaction using a Tetrahedral Palladium Supported Titania Catalyst

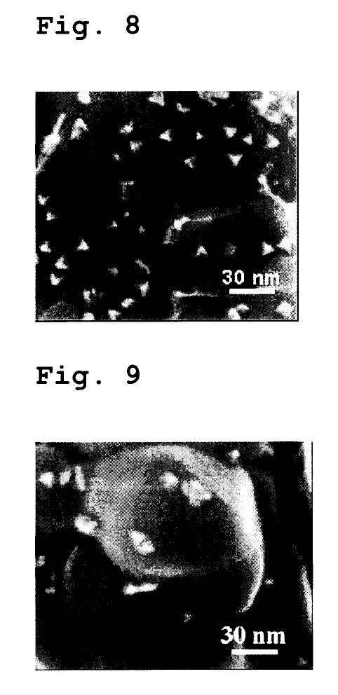

In Example 14, with the exceptions of using the palladium supported titania catalysts obtained in Example 9 and Example 10, namely PCB(DMA)/TiO₂^{0 min} and PCB(DMA)/TiO₂⁷⁰ ml, instead of the palladium colloid used as the catalyst, and altering the reaction time to 5 hours, processing was performed in the same manner as Example 14, and yielded biphenyl with a yield of 89% and 67%, respectively. FE-SEM images of the catalyst of Example 9 before and after the C—C bond-forming reaction are shown in FIG. 8 and FIG. 9, respectively. It was confirmed that even after the C—C bond-forming reaction, the tetrahedral fine palladium particles had retained their tetrahedral shape, fine particle size, and dispersibility on the carrier.

### Example 18

### C—C Bond-Forming Reaction using a Tetrahedral Palladium Supported Alumina Catalyst

In Example 14, with the exceptions of replacing the palladium colloid used as the catalyst with the tetrahedral palladium supported alumina catalysts PCA(NMP)/Al₂O₃^{0 min} obtained in Example 11 and Example 12, and altering the reaction time to 3 hours, processing was performed in the same manner as Example 14, and yielded biphenyl with a yield of >99% and 92%, respectively.

### Comparative Example 3

### C—C Bond-Forming Reaction using a Commercially Available Palladium Supported Alumina Catalyst

In Example 18, with the exception of replacing the tetrahedral palladium supported alumina catalyst used as the catalyst with a quantity of a commercially available palladium supported alumina catalyst 5% Pd/Al₂O₃ (manufactured by Wako Pure Chemical Industries, Ltd.) equivalent to 0.01 mmol of Pd, processing was performed in the same manner as Example 18, and yielded biphenyl with a yield of 53%.

### Example 19

### C—C Bond-Forming Reaction using a Tetrahedral Palladium Supported Hydroxyapatite Catalyst

In Example 14, with the exceptions of replacing the palladium colloid used as the catalyst with the supported hydroxyapatite catalyst obtained in Example 13, and altering the reaction time to 5 hours, processing was performed in the same manner as Example 14, and yielded biphenyl with a yield of 75%.

### Example 20

### Acetylene Hydrogenation Reaction using a Tetrahedral Palladium Colloidal Catalyst

A Pyrex (a registered trademark) flask was charged with 5 ml of DMSO solvent, phenylacetylene (1.0 mmol) was added thereto, and following flushing of the inside of the flask with hydrogen gas under stirring, the temperature was raised using an oil bath until the liquid temperature reached 40° C., and 5 mg of the tetrahedral palladium supported titania catalyst PCB(DMA)^{0 min}/TiO₂ obtained in Example 7 (equivalent to 2.5 μmol of Pd) was added. After supplying hydrogen at normal pressure for 3 hours, the reaction liquid was analyzed by gas chromatography (using an internal standard method), which revealed that the styrene produced by hydrogenation of only the C—C triple bond had been obtained with a yield of 96%.

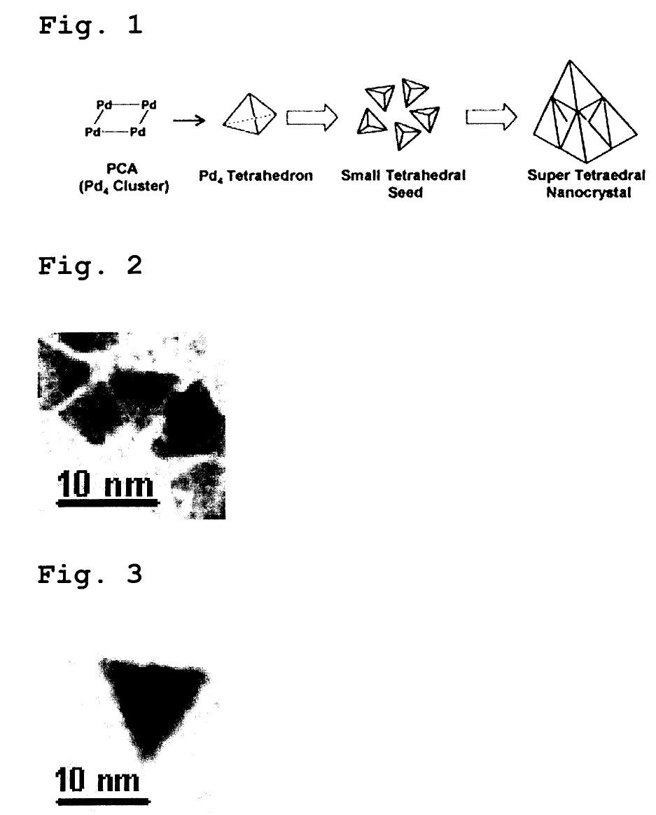

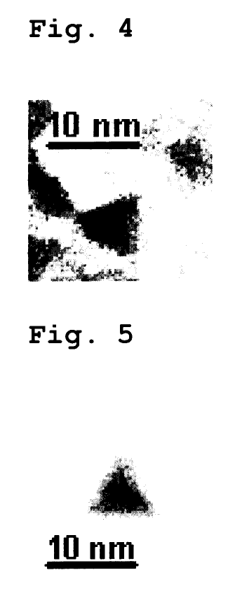

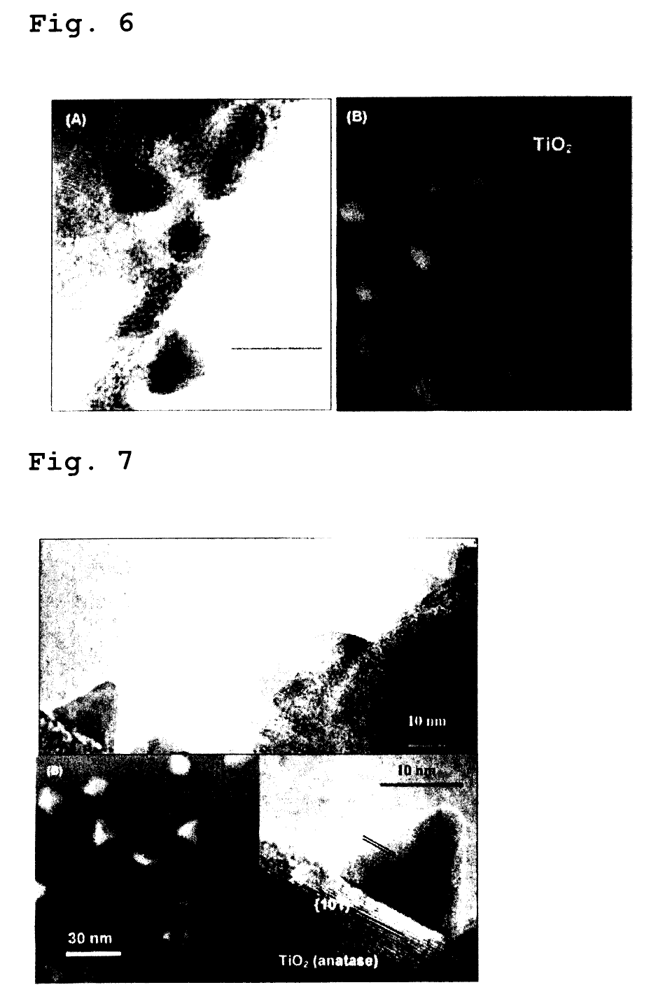

### BRIEF DESCRIPTION OF DRAWINGS

[FIG. 1] A scheme showing the production of tetrahedral fine metal particles of the present invention.

[FIG. 2] An electron microscope photograph (HR-TEM image) of a tetrahedral palladium colloid PCA(DMA)^{5 min} of the present invention.

[FIG. 3] An electron microscope photograph (HR-TEM image) of a tetrahedral palladium colloid PCA(DMA)^{70 min} of the present invention.

[FIG. 4] An electron microscope photograph (HR-TEM image) of a tetrahedral palladium colloid PCB(DMA)^{0 min} of the present invention.

[FIG. 5] An electron microscope photograph (HR-TEM image) of a tetrahedral palladium colloid PCB(DMA)^{70 min} of the present invention.

[FIG. 6] (A) and (B) show electron microscope photographs (an HR-TEM image and FE-SEM image, respectively) of a tetrahedral palladium supported catalyst PCA(DMA)/TiO₂^{0 min} of the present invention.

[FIG. 7] (A), (B) and (C) show electron microscope photographs (an HR-TEM image, FE-SEM image, and high-magnification HR-TEM image, respectively) of a tetrahedral palladium supported catalyst PCA(DMA)/TiO₂^{70 min} of the present invention.

[FIG. 8] An electron microscope photograph (a FE-SEM image) of a tetrahedral palladium supported titania catalyst PCB(DMA)/TiO₂^{0 min} of the present invention before a C—C bond-forming reaction.

[FIG. 9] An electron microscope photograph (a FE-SEM image) of a tetrahedral palladium supported titania catalyst PCB(DMA)/TiO₂^{0 min} of the present invention after a C—C bond-forming reaction.

1: Fine palladium particles, comprising particles having a tetrahedral shape in a proportion of 60 to 100% by number of particles.

2: The fine palladium particles according to claim 1, comprising particles having a tetrahedral shape in a proportion of 72 to 95% by number of particles.

3: The fine palladium particles according to claim 1, wherein a number average particle size of the particles is within a range from 0.5 to 100 nm.

4: The fine palladium particles according to claim 3, wherein a number average particle size of the particles is within a range from 1 to 50 nm.

5: The fine palladium particles according to claim 4, wherein a number average particle size of the particles is within a range from 1 to 30 nm.

6: A palladium colloid, obtained by uniformly dispersing the fine palladium particles defined in claim 1 within a solvent.

7: The palladium colloid according to claim 6, wherein the solvent is an aprotic polar solvent.

8: The palladium colloid according to claim 6, wherein the colloid comprises no protective agent.

9: The palladium colloid according to claim 6, wherein the colloid comprises no surfactant.

10: The palladium colloid according to claim 6, further comprising a protective agent.

11: A supported catalyst, comprising the fine particles defined in claim 1 dispersedly supported on a surface of, and/or in pores of, a carrier comprising at least one of a ceramic, a carbon, and an organic polymer.

12: The supported catalyst according to claim 11, wherein the carrier is a titania, alumina, silica, silica-alumina, zeolite, hydroxyapatite, or carbon.

13: A catalyst for at least one reaction selected from the group consisting of carbon-carbon bond-forming reactions, hydrogenation reactions, hydrocracking reactions, oxidation reactions and dehydrogenation reactions, comprising the palladium colloid defined in claim 6.

14: A process for producing fine metal particles, the process comprising: dissolving a tetranuclear precursor metal complex within an organic solvent to generate a uniform solution, and shape-selectively generating tetrahedral particles by decomposing the metal complex within the uniform solution.

15: The process according to claim 14, wherein decomposition of the precursor metal complex is conducted within an oxygen-containing atmosphere.

16: The process according to claim 14, wherein the precursor metal complex comprises a carbonyl ligand.

17: The process according to claim 14, wherein the precursor metal complex comprises an aliphatic or aromatic carboxylate ligand.

18: The process according to claim 14, wherein the precursor metal complex is dissolved in an aprotic polar organic solvent.

19: The process according to claim 18, wherein the polar organic solvent is a carboxylic acid amide.

20: The process according to claim 14, wherein the fine metal particles are fine palladium particles.

21: A process for producing the catalyst defined in claim 11, comprising bringing a palladium colloid, obtained by uniformly dispersing within a solvent fine palladium particles comprising particles having a tetrahedral shape in a proportion of 60 to 100% by number of particles, into contact with a carrier comprising at least one of a ceramic, a carbon, and an organic polymer.

22: A catalyst for at least one reaction selected from the group consisting of carbon-carbon bond-forming reactions, hydrogenation reactions, hydrocracking reactions, oxidation reactions and dehydrogenation reactions, comprising the supported catalyst according to claim 11.
